(19) United States
(12) Patent Application Publication
(10) Pub. No.: US 2025/0208538 A1
(43) Pub. Date: Jun. 26, 2025

(54) IMAGE FORMING APPARATUS

(71) Applicant: CANON KABUSHIKI KAISHA, Tokyo (JP)

(72) Inventor: Tomonori Yuyama, Tokyo (JP)

(21) Appl. No.: 18/985,664

(22) Filed: Dec. 18, 2024

(30) Foreign Application Priority Data
Dec. 26, 2023 (JP) 2023-218771
Oct. 24, 2024 (JP) 2024-187307

(51) Int. Cl. G03G 15/08; G03G 15/00

(52) U.S. Cl. CPC G03G 15/0889; G03G 15/086; G03G 15/0865; G03G 15/0891; G03G 15/556

(57) ABSTRACT

A controller executes first control and second control. In first control, a developer replenishment unit replenishes developer to a developing container based on an output value of a first magnetic permeability sensor that is generated while the driving unit rotatably drives the conveyance screw. In the second control, a vibration unit performs a vibration operation to apply the vibrations to the developing unit based on an output value of the second magnetic permeability sensor that is generated while the driving unit rotatably drives the conveyance screw.

### BACKGROUND OF THE INVENTION

### Field of the Invention

The present invention relates to an image forming apparatus.

### Description of the Related Art

In image forming apparatuses using an electrophotographic system, an electrostatic latent image formed on an image bearing member is developed as a toner image using a developing unit. As such the developing unit, hitherto, one that uses two-component developer containing toner and magnetic carrier has been utilized. In the developing unit that use the two-component developer, the auto carrier refresh (ACR) method is widely adopted to suppress carrier degradation. In the ACR method, toner containing a trace amount of the carrier is replenished to the developing unit, and the excess developer resulting from such replenishment is simultaneously discharged outside of the developing unit.

In the developing unit that employs the ACR method, it is necessary to maintain the developer within the developing unit at a constant amount to maintain the quality of the developed image consistent. US2019/0033750 proposes a developing unit that indirectly predicts a developer amount within the developing unit by using a sensor that detects the height of a developer surface (bulk height) within the developing unit, and, based on that result, adjusts the developer amount within the developing unit by controlling, for example, a rotational speed of a conveyance screw.

In the developing unit of US2019/0033750, the height of the developer surface within the developing unit is detected by measuring the magnetic permeability of the developer within the developing unit. In an inductance sensor that measures the magnetic permeability of the developer, changes in an amount of the magnetic carrier present in the developer are detected as changes in the apparent magnetic permeability. Thereby, when the developer surface rises, the magnetic permeability increases due to an increase in the amount of the magnetic carrier in the vicinity the sensor, and an output value of the sensor increases. Conversely, when the developer surface falls and the magnetic carrier in the vicinity the sensor decreases, the output value of the sensor decreases. From the relationship of the sensor output response with respect to the changes in the developer surface, it is possible to accurately predict the developer surface.

However, as the usage of the developing unit continues, sometimes, the fluidity of the developer within the developing unit decreases. Then, when the fluidity of the developer decreases, sometimes, there is a risk that an immobile layer of the developer is formed in the vicinity of a detection surface of the induction sensor. In such a case, there is a risk that the output value of the induction sensor may become saturated near an upper limit value due to the influence of the immobile layer, and the developer surface may not be detected correctly.

In a case of a configuration described in US2019/0033750, when it is detected that the height of the developer surface is higher than the upper limit based on the output value of the sensor, a developer discharge mode is executed to increase a discharge amount of the developer by, such as, accelerating a speed of a conveyance screw. Therefore, if the output value of the induction sensor becomes saturated near the upper limit value due to the influence of the immobile layer, and the developer surface cannot be detected correctly, the developer discharge mode cannot be executed properly.

### SUMMARY OF THE INVENTION

The present invention provides an image forming apparatus that can properly perform control in accordance with a developer surface.

According to a first aspect of the present invention, an image forming apparatus includes an image bearing member, a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container, a driving unit configured to rotatably drive the conveyance screw, a developer replenishment unit configured to replenish the developer to the developing container, a vibration unit configured to apply vibrations to the developing unit, and, a controller. The second detection portion is located vertically upper than the first detection portion. The controller is configured to execute first control to control the developer replenishment unit to replenish the developer to the developing container based on an output value of the first magnetic permeability sensor that is generated while the driving unit rotatably drives the conveyance screw. The controller is configured to execute second control to control the vibration unit to perform a vibration operation to apply the vibrations to the developing unit based on an output value of the second magnetic permeability sensor that is generated while the driving unit rotatably drives the conveyance screw.

According to a second aspect of the present invention, an image forming apparatus includes an image bearing member, a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container, a driving unit configured to rotatably drive the conveyance screw, a developer replenishment unit configured to replenish the developer to the developing container, a vibration unit configured to apply vibrations to the developing unit, and, a controller. The second detection portion is located vertically upper than the first detection portion. The controller is configured to execute first control to control the developer replenishment unit to replenish the developer to the developing container based on an output value of the first magnetic permeability sensor that is generated while the driving unit rotatably drives the conveyance screw. In a case where an absolute value of a difference between a maximum output value and a minimum output value of the second magnetic permeability sensor that are generated while the driving unit rotatably drives the conveyance screw for a predetermined time, is smaller than a predetermined value, the controller is configured to execute second control to control the vibration unit to perform a vibration operation to apply the vibrations to the developing unit. In a case where the absolute value of the difference between the maximum output value and the minimum output value of the second magnetic permeability sensor that are generated while the driving unit rotatably drives the conveyance screw for the predetermined time, is equal to or more than the predetermined value, the controller is configured not to execute the second control.

According to a third aspect of the present invention, an image forming apparatus includes an image bearing member, a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container, a driving unit configured to rotatably drive the conveyance screw, a developer replenishment unit configured to replenish the developer to the developing container, a vibration unit configured to apply vibrations to the developing unit, and, a controller. The second detection portion is located vertically upper than the first detection portion. The controller is configured to execute first control to control the developer replenishment unit to replenish the developer to the developing container based on an output value of the first magnetic permeability sensor that is generated while the driving unit rotatably drives the conveyance screw. In a case where an integral value of an output value of the second magnetic permeability sensor that is generated while the driving unit rotatably drives the conveyance screw for a predetermined time, is larger than a predetermined integral value, the controller is configured to execute second control to control the vibration unit to perform a vibration operation to apply the vibrations to the developing unit. In a case where the integral value of the output value of the second magnetic permeability sensor that is generated while the driving unit rotatably drives the conveyance screw for the predetermined time, is equal to or less than the predetermined integral value, the controller is configured not to execute the second control.

According to a fourth aspect of the present invention, an image forming apparatus includes an image bearing member, a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container, a driving unit configured to rotatably drive the conveyance screw, a developer replenishment unit configured to replenish the developer to the developing container, a vibration unit configured to apply vibrations to the developing unit, and, a controller. The second detection portion is located vertically upper than the first detection portion. The controller is configured to execute first control to control the developer replenishment unit to replenish the developer to the developing container based on an output value of the first magnetic permeability sensor that is generated while the driving unit rotatably drives the conveyance screw. In a case where a standard deviation of an output value of the second magnetic permeability sensor that is generated while the driving unit rotatably drives the conveyance screw for a predetermined time, is smaller than a predetermined standard deviation, the controller is configured to execute second control to control the vibration unit to perform a vibration operation to apply the vibrations to the developing unit. In a case where the standard deviation of the output value of the second magnetic permeability sensor that is generated while the driving unit rotatably drives the conveyance screw for the predetermined time, is equal to or more than the predetermined standard deviation, the controller is configured not to execute the second control.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic configuration of an image forming apparatus according to a first embodiment.

FIG. 2 is a control block diagram of the image forming apparatus according to the first embodiment.

FIG. 3 is a cross-sectional view illustrating a schematic configuration of a developing unit according to the first embodiment.

FIG. 4 is a schematic diagram illustrating the developing unit according to the first embodiment, when cut along a direction parallel to a rotational axis of a first developing roller.

FIG. 5A is a diagram illustrating a schematic configuration of a vibration device according to the first embodiment when viewed from above.

FIG. 5B is a diagram illustrating the schematic configuration of the vibration device according to the first embodiment when viewed from the side.

FIG. 6 is a cross-sectional view illustrating a schematic configuration of the developing unit according to the first embodiment in a case where the fluidity of the developer is high.

FIG. 7 is a graph illustrating an output value of a developer surface detection sensor in the case where, in the developing unit according to the first embodiment, the fluidity of the developer is high.

FIG. 8 is a graph illustrating a relationship between the developer surface and an average output value of the developer surface detection sensor in the case where, in the developing unit according to the first embodiment, the fluidity of the developer is high.

FIG. 9 is a cross-sectional view illustrating a schematic configuration of the developing unit according to the first embodiment in a case where an immobile layer of the developer is generated.

FIG. 10 is a graph illustrating the output value of the developer surface detection sensor in the case where the immobile layer of the developer is generated in the developing unit according to the first embodiment.

FIG. 11 is a graph illustrating the relationship between the developer surface and the average output value of the developer surface detection sensor in the case where the immobile layer of the developer is generated in the developing unit according to the first embodiment.

FIG. 12 is a graph illustrating a relationship between an immobile layer index of the developer and Vpp of the developer surface detection sensor in the developing unit according to the first embodiment.

FIG. 13 is a flowchart illustrating control relating to the execution of a vibration operation according to the first embodiment.

FIG. 14 is a flowchart illustrating control relating to the execution of the vibration operation and a developer discharge mode according to a second embodiment.

### DESCRIPTION OF THE EMBODIMENTS

### First Embodiment

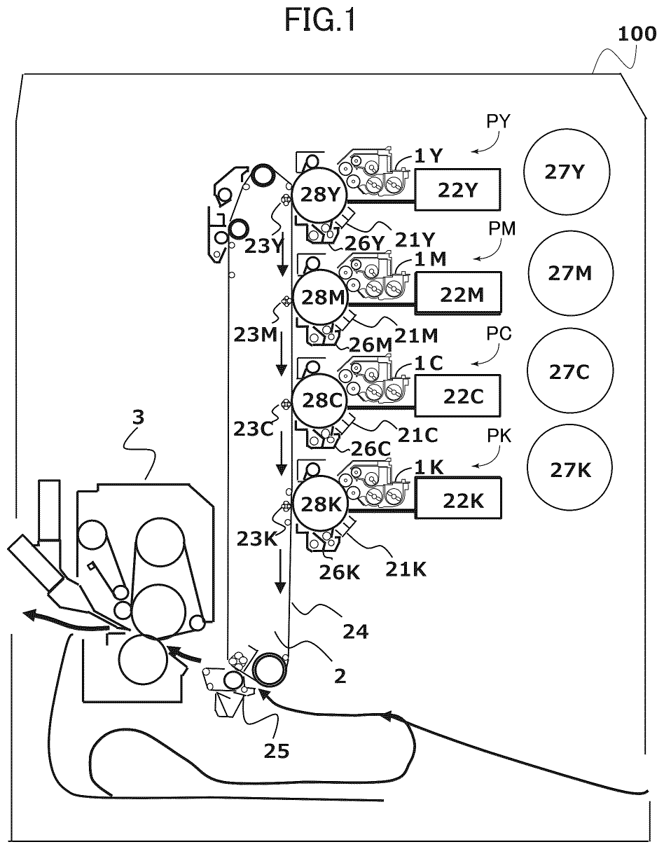

A first embodiment will be described with reference to FIGS. 1 to 13. First, a schematic configuration of an image forming apparatus of the present embodiment will be described with reference to FIG. 1.

### Image Forming Apparatus

The image forming apparatus 100 is a full color image forming apparatus, and, in the present embodiment, is a multi-function peripheral (MFP) incorporating, for example, a copying function, a printing function, and a scanning function. In the image forming apparatus 100, as illustrated in FIG. 1, image forming units PY, PM, PC, and PK, each performing the formation of toner images in four colors of yellow, magenta, cyan, and black, are arranged in parallel.

The image forming units PY, PM, PC, and PK of each color include a primary charge units 21Y, 21M, 21C, and 21K, developing units 1Y, 1M, 1C, and 1K, optical writing units (exposing units) 22Y, 22M, 22C, and 22K, photosensitive drums 28Y, 28M, 28C, and 28K, and cleaning units 26Y, 26M, 26C, and 26K. In addition, the image forming apparatus 100 includes a transfer unit 2 and a fixing unit 3. To be noted, since configurations of the image forming units PY, PM, PC, and PK of each color are similar, the following description will proceed using the image forming unit PY as a representative.

The photosensitive drum 28Y, serving as a rotatable image bearing member, is a photoreceptor with a photosensitive layer made from a resin such as polycarbonate containing an organic photoconductor (OPC), and is configured to rotate at a predetermined speed. The primary charge unit 21Y includes a corona discharge electrode arranged around the photosensitive drum 28Y, and charges a surface of the photosensitive drum 28Y using generated ions.

A scanning optical device is incorporated in the optical writing unit 22Y, and, by exposing the charged photosensitive drum 28Y based on image data, the optical writing unit 22Y reduces the electric potential of an exposed area, so that a charge pattern (electrostatic latent image) corresponding to the image data is formed on the photosensitive drum 28Y. By transferring accommodated developer to the photosensitive drum 28Y, the developing unit 1Y develops the electrostatic latent image formed on the photosensitive drum 28Y. The developer is formed by mixing carrier with toner corresponding to each color. The electrostatic latent image is visualized by the toner.

The transfer unit 2 includes primary transfer rollers 23Y, 23M, 23C, and 23K, an intermediate transfer belt 24, and a secondary transfer roller 25. The intermediate transfer belt 24 is wound around by the primary transfer rollers 23Y, 23M, 23C, and 23K and a plurality of rollers, and is supported in a travelable manner. From top to bottom in FIG. 1, each of the primary transfer rollers 23Y, 23M, 23C, and 23K corresponds to each of colors of yellow (Y), magenta (M), cyan (C), and black (K). The secondary transfer roller 25 is arranged outside of the intermediate transfer belt 24, and is configured such that a recording material can pass through a gap with the intermediate transfer belt 24. To be noted, the recording material includes a sheet such as paper and a plastic sheet.

The toner images of each color formed on the photosensitive drums 28Y, 28M, 28C, and 28K are transferred onto the intermediate transfer belt 24 by the primary transfer rollers 23Y, 23M, 23C, and 23K in sequence, and the toner image with color is formed by superimposing each layer of yellow, magenta, cyan, and black colors. The formed toner image is transferred onto the recording material, which is conveyed from a cassette or the like storing the recording material, by the secondary transfer roller 25. In the fixing unit 3, heat and pressure are applied to the recording material onto which the toner image has been transferred. Thereby, the toner on the recording material is melted, and the color image is fixed on the recording material.

Developer storage units 27Y, 27M, 27C, and 27K are disposed corresponding to each of the developing units 1Y, 1M, 1C, and 1K, and bottles of the developer storage units 27Y, 27M, 27C, and 27K storing the developers respectively corresponding to colors of yellow, magenta, cyan, and black are loaded in a replaceable manner. The developer storage units 27Y, 27M, 27C, and 27K are configured to convey (replenish) the developer to the developing units 1Y, 1M, 1C, and 1K corresponding to the color of the developer which is stored.

For example, a toner weight ratio, that is, toner concentration, in the developer accommodated in the bottles is 85 to 95%, and a toner weight ratio in the developing units 1Y, 1M, 1C, and 1K is 5 to 10%. The toner concentration is a ratio of the toner weight with respect to the total weight of the carrier and the toner. Therefore, when the toner is consumed during development in the developing units 1Y, 1M, 1C, and 1K, the developer containing the toner is replenished corresponding to its consumed amount, and the toner weight ratio in the developer within the developing units 1Y, 1M, 1C, and 1K is maintained constant.

### Control Configuration

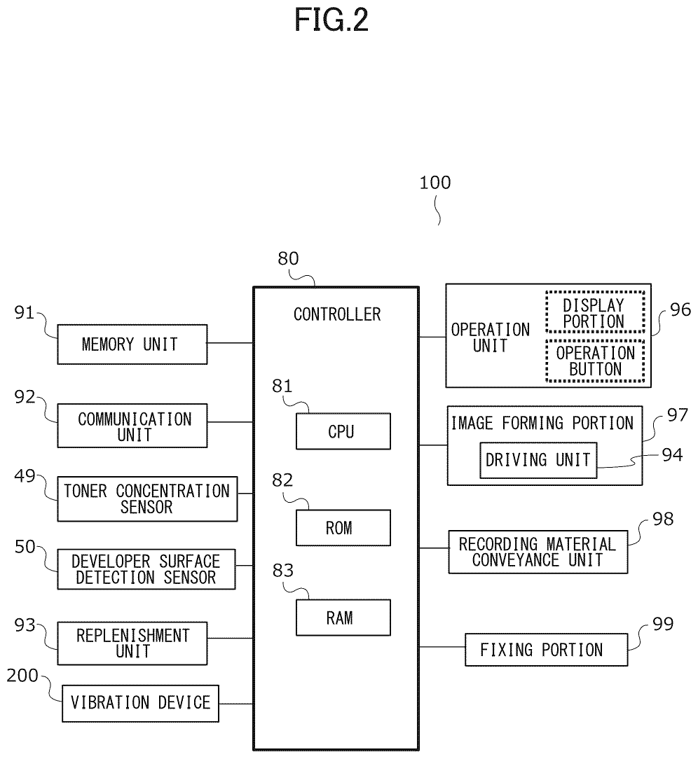

FIG. 2 is a block diagram illustrating a main part of a control system of the image forming apparatus 100. The image forming apparatus 100 includes an operation unit 96, an image forming portion 97, a recording material conveyance unit 98, a fixing portion 99, and a controller 80. The operation unit 96 includes a display portion capable of displaying various information, an operation button, and the like. The display portion may also be a touch panel that allows a touch operation. The image forming portion 97 includes various motors that drive configurations such as the image forming portions PY, PM, PC, and PK, the photosensitive drums 28Y, 28M, 28C, and 28K, and the developing units 1Y, 1M, 1C, and 1K to form the image on the recording material as described above, as well as power sources that apply voltage to these configurations. The image forming portion 97 includes a driving unit 94 such as a motor that rotatably drives a developer supply screw 42 and a developer agitation screw 43, described below. The recording material conveyance unit 98 includes various motors that drive conveyance rollers conveying the recording material. The fixing portion 99 includes a heater of the fixing unit 3 and a motor that drives the fixing unit 3. These operation unit 96, image forming portion 97, recording material conveyance unit 98, and fixing portion 99 are connected to the controller 80, and are controlled by the controller 80.

The controller 80 includes a central processing unit (CPU) 81, a read only memory (ROM) 82, a random access memory (RAM) 83, and the like. The CPU 81 reads programs corresponding to processing requirements from the ROM 82, loads them into the RAM 83, and control operations of each configuration of the image forming apparatus 100 by coordinating with the loaded programs. At this time, various data stored in a memory unit 91 is referenced.

The memory unit 91 is configured with, for example, a non-volatile semiconductor memory (so-called flash memory) or a hard disk drive. Through a communication unit 92, the controller 80 performs the transmission and reception of the various data with an external apparatus (e.g., a personal computer) connected to a communication network such as a local area network (LAN) and a wide area network (WAN). The controller 80, for example, receives image data (input image data) transmitted from the external apparatus, and forms the image on the recording material based on the image data. The communication unit 92 is configured with a communication control card such as a LAN card.

In addition, a toner concentration sensor 49, a developer surface detection sensor 50, a replenishment unit 93, and a vibration device 200 are connected to the controller 80. The toner concentration sensor 49 is disposed in each of the developing units 1Y, 1M, 1C, and 1K, and, as described below, detects the toner concentration of the developer within the developing units 1Y, 1M, 1C, and 1K. Also, the developer surface detection sensor 50 is disposed in each of the developing units 1Y, 1M, 1C, and 1K, and, as described below, detects respective developer surfaces within the developing units 1Y, 1M, 1C, and 1K. The replenishment unit 93, serving as a developer replenishment unit, includes a motor that drives a replenishment mechanism supplying the developer from each of the developer storage units 27Y, 27M, 27C, and 27K to the respective developing units 1Y, 1M, 1C, and 1K. The vibration device 200, as described below, applies vibrations to each of the developing units 1Y, 1M, 1C, and 1K. The controller 80 controls the replenishment unit 93 and the vibration device 200 based on detection results of the toner concentration sensor 49 and the developer surface detection sensor 50.

### Developing Unit

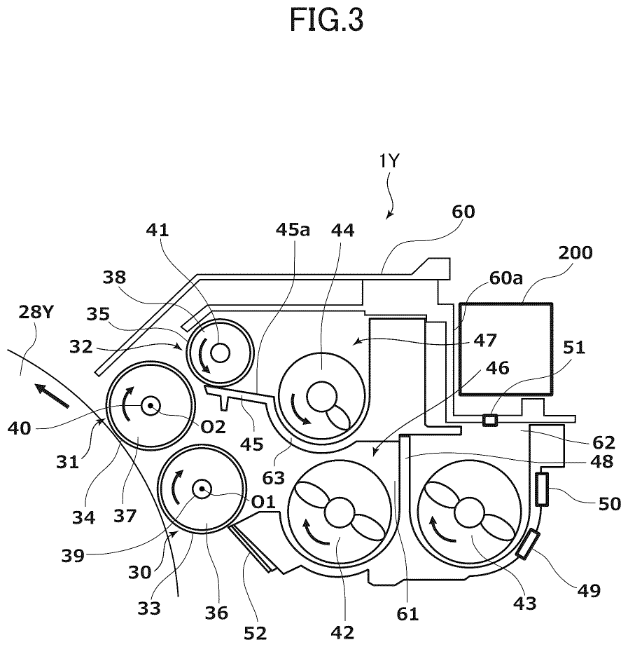

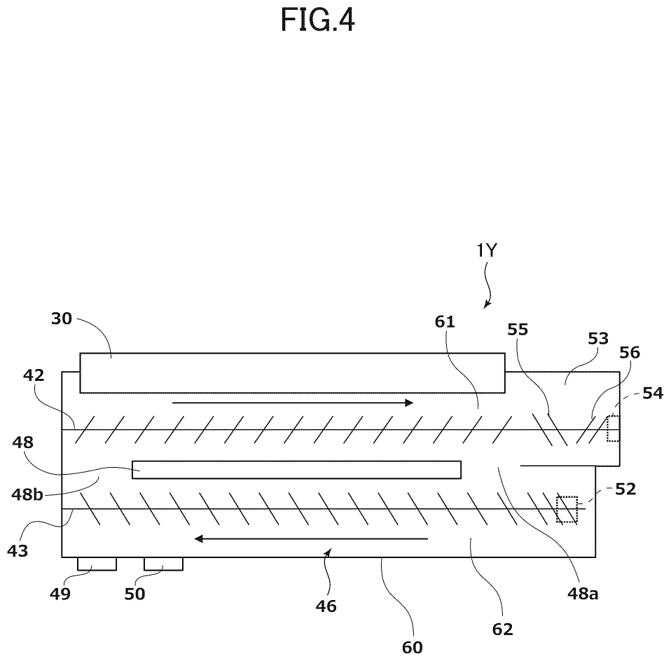

Next the developing units 1Y, 1M, 1C, and 1K will be described in detail with reference to FIGS. 3 and 4. To be noted, since configurations of the developing units 1Y, 1M, 1C, and 1K are the same, hereinafter, as a representative, the developing unit 1Y will be described. FIG. 3 is a schematic diagram illustrating the developing unit 1Y illustrated in FIG. 1, and FIG. 4 is a schematic diagram illustrating the developing unit 1Y when cut along a direction parallel to a rotational axis of a first developing roller 30 and viewed from above.

As illustrated in FIG. 3, the developing unit 1Y includes the first developing roller 30, a second developing roller 31, a peeling roller 32, the developer supply screw 42, the developer agitation screw 43, and a developer collection screw 44, and these members are accommodated in a developing container 60.

The first developing roller 30 is a developer bearing member (rotatable developing member) that is rotatably driven, and is arranged at a position adjacent to the photosensitive drum 28Y such that its rotational axis is substantially parallel to a rotational axis of the photosensitive drum 28Y. The first developing roller 30 includes a rotating first sleeve 33 and a non-rotating first magnet (fixed magnet) 36, which is arranged within the first sleeve 33 and utilizes a magnetic force to attract the developer onto a surface of the first sleeve 33. Then, the first developing roller 30 attracts (bears) the developer drawn from the developer supply screw 42 based on the magnetic force, and develops the electrostatic latent image formed on the rotating photosensitive drum 28Y (on the image bearing member) using the developer.

The first sleeve 33 is a non-magnetic cylindrical member, and is rotatably driven about a rotation shaft 39. A rotational direction of the first sleeve 33 is a clockwise direction as illustrated by an arrow in FIG. 3, and, in the present embodiment, is opposite to a rotational direction of the photosensitive drum 28Y. Therefore, the first sleeve 33 and the photosensitive drum 28Y rotate in the same direction at positions facing each other. That is, the photosensitive drum 28Y performs a forward development operation in which the photosensitive drum 28Y rotates from vertically below toward vertically above at the position facing the first sleeve 33. Between an inner circumferential surface of the first sleeve 33 and an outer circumferential surface of the first magnet 36, a space that allows the rotation of the first sleeve 33 is arranged.

The developer attracted onto the first sleeve 33 is conveyed toward the photosensitive drum 28Y by a rotational operation of the first sleeve 33, and develops the electrostatic latent image formed on the photosensitive drum 28Y. After the development of the electrostatic latent image formed on the photosensitive drum 28Y, the developer on the first sleeve 33 is conveyed to a position adjacent to the second developing roller 31. Then, at a position adjacent to the closest position between the first and second developing rollers 30 and 31, through a magnetic field generated by the first magnet 36 arranged in the first developing roller 30 and a magnetic field generated by a second magnet 37 arranged in the second developing roller 31, the developer is peeled from the first sleeve 33, and is transferred onto the second sleeve 34.

The second developing roller 31 of the developing unit 1Y of the present embodiment is arranged above the first developing roller 30 in the vertical direction, as described next. Therefore, the transfer of the developer from the first sleeve 33 to a second sleeve 34 also needs to occur from vertically below to vertically above, against gravity. To be noted, the first and second sleeves 33 and 34 are arranged with a predetermined gap at the closest position.

The second developing roller 31 is the developer bearing member that is rotatably driven. The second developing roller 31 is arranged downstream of the first developing roller 30 in the rotational direction of the photosensitive drum 28Y such that a rotation center 02 of the second developing roller 31 is arranged to be above a rotation center 01 of the first developing roller 30 in the vertical direction. The second developing roller 31 is transferred the developer from the first developing roller 30 through the magnetic force. In the present embodiment, the entire second developing roller 31 is positioned above the rotation center 01 of the first developing roller 30. Similar to the first developing roller 30, the second developing roller 31 is arranged at a position adjacent to the photosensitive drum 28Y such that its rotational axis is substantially parallel to the rotational axis of the photosensitive drum 28Y. Therefore, the rotational axes of the second and first developing rollers 31 and 30 are substantially parallel to each other.

The second developing roller 31 as described above includes the rotating second sleeve 34 and the second magnet (fixed magnet) 37 that is arranged in the non-rotating manner within the second sleeve 34 and utilizes the magnetic force to attract the developer onto a surface of the second sleeve 34. Then, based on the magnetic force, the developer is transferred from the first developing roller 30 (the first sleeve 33) to the second developing roller 31, and is attracted (borne) onto the second developing roller 31. The second developing roller 31 develops the electrostatic latent image formed on the rotating photosensitive drum 28Y using the developer. To be noted, the peeling roller 32, described below, is positioned to the side of the second developing roller 31.

The second sleeve 34 is the non-magnetic cylindrical member, and is rotatably driven about a rotation shaft 40. A rotational direction of the second sleeve 34 is the same clockwise direction as the first sleeve 33 as illustrated by an arrow in FIG. 3, and, in the present embodiment, is opposite to the rotational direction of the photosensitive drum 28Y. Therefore, the second sleeve 34 and the photosensitive drum 28Y are rotating in the same direction at positions facing each other. That is, the photosensitive drum 28Y performs the forward development operation in which the photosensitive drum 28Y rotates from vertically below toward vertically above at the position facing the second sleeve 34. In addition, the second and first sleeves 34 and 33 rotate in opposite directions at positions facing each other. Between an inner circumferential surface of the second sleeve 34 and an outer circumferential surface of the second magnet 37, a space that allows the rotation of the second sleeve 34 is arranged.

The developer attracted onto the second sleeve 34 is conveyed toward the photosensitive drum 28Y by a rotational operation of the second sleeve 34, and develops the electrostatic latent image formed on the photosensitive drum 28Y. After the development of the electrostatic latent image formed on the photosensitive drum 28Y, the developer remained on the second sleeve 34 is conveyed to a position adjacent to the peeling roller 32 by the rotational operation of the second sleeve 34. Then, at a position adjacent to the closest position between the second developing roller 31 and the peeling roller 32, the developer is transferred from the second sleeve 34 onto the peeling roller 32 through the magnetic field generated by the second magnet 37 arranged in the second developing roller 31 and a magnetic field generated by a third magnet 38 arranged in the peeling roller 32.

The peeling roller 32, serving as a peeling unit, is arranged opposite to the photosensitive drum 28Y with respect to the rotation center of the second sleeve 34, and peels the developer, which remains on the second developing roller 31 after the electrostatic latent image on the photosensitive drum 28Y is developed by the second developing roller 31, from the second developing roller 31. In particular, the peeling roller 32 is the developer bearing member that is rotatably driven, and is arranged between the second developing roller 31 and the developer collection screw 44. A rotation center of the peeling roller 32 is arranged to be above the rotation center 02 of the second developing roller 31.

The peeling roller 32 is arranged such that a rotational axis of the peeling roller is substantially parallel to the rotational axis of the second developing roller 31. The peeling roller 32 as described above includes the rotating third sleeve 35 and the third magnet (fixed magnet) 37, which is arranged in a non-rotating manner within the third sleeve 35 and utilizes the magnetic force to attract the developer onto a surface of the third sleeve 35, and transfers the developer from the second developing roller 31 based on the magnetic force.

The third sleeve 35 is the non-magnetic cylindrical member, and is rotatably driven about a rotation shaft 41. A rotational direction of the third sleeve 35 is a counter-clockwise direction as illustrated by an arrow in FIG. 3, and, in the present embodiment, is opposite to the rotational direction of the second sleeve 34. Therefore, the third and second sleeves 35 and 34 are rotating in the same direction at positions facing each other. Between an inner circumferential surface of the third sleeve 35 and an outer circumferential surface of the third magnet 38, a space that allows the rotation of the third sleeve 35 is arranged.

The developer attracted onto the third sleeve 35 is conveyed downstream in the rotational direction by a rotational operation of the third sleeve 35, and is peeled off from the third sleeve 35 at a position adjacent to the developer collection screw 44 by the third magnet 38 arranged in the peeling roller 32, and falls by its own weight toward a guide member 45 positioned vertically below. Then, the developer that has fallen to the guide member 45 is guided by its own weight toward the developer collection screw 44.

The guide member 45 and the developer collection screw 44 constitute a developer collection portion 47, serving as a collection unit that collects the developer peeled off from the third sleeve 35 on the peeling roller 32. In the developer collection portion 47, a rotation center of the developer collection screw 44 is arranged to be positioned below the rotation center of the peeling roller 32 in the vertical direction, and the developer collection screw 44 conveys the developer transferred (collected) from the peeling roller 32 while agitating.

The guide member 45, serving as a guide unit, is arranged vertically below the peeling roller 32, and guides the developer, which has been peeled off by the peeling roller 32, toward the developer collection screw 44. For more securely guiding the developer toward the developer collection screw 44, such a guide member 45 includes an inclined surface 45a on which the developer slides down by its own weight. The inclined surface 45a is inclined with respect to a horizontal direction such that a portion on a side of the developer collection screw 44 is lower than a portion below the peeling roller 32.

The developer collection screw 44, serving as a collection member and a conveyance unit, conveys the collected developer to a developer circulation portion 46, described next. That is, the developer collection screw 44 is a screw conveyance member that is used to convey the developer, which has been collected by sliding down the inclined surface of the guide member 45, in one direction while agitating.

The developer circulation portion 46 is a supply portion for supplying the developer to the first developing roller 30, and includes the developer supply screw 42, serving as a first conveyance screw, and the developer agitation screw 43, serving as a second conveyance screw. The developer supply screw 42 and the developer agitation screw 43 are rotatably driven by the driving unit 94. In the developer circulation portion 46, the developer is supplied to the first developing roller 30 while being conveyed substantially in the horizontal direction and agitated by the developer supply screw 42 and the developer agitation screw 43. In addition, as described above, the developer that has been collected by the developer collection portion 47 falls by its own weight, and is introduced into the developer circulation portion 46.

The developer supply screw 42, the developer agitation screw 43, and the developer collection screw 44 are the screw conveyance members that convey the developer to one direction while agitating, and the developer supply screw 42 and the developer agitation screw 43 are positioned vertically below the developer collection screw 44. In addition, the rotational axes of these developer supply screw 42, developer agitation screw 43, and developer collection screw 44 are arranged to be substantially parallel to each other. The rotational axes of these screws are also substantially parallel to the rotational axis of the first developing roller 30.

The developer supply screw 42 is positioned between the first developing roller 30 and the developer agitation screw 43, and a partition wall 48 of the developing container 60 is arranged between the developer supply screw 42 and the developer agitation screw 43. The partition wall 48 of the developing container 60 is arranged to extend along the rotational axis directions of the developer supply screw 42 and the developer agitation screw 43.

Communication ports 48a and 48b (FIG. 4) communicating between a first conveyance path 61, serving as a first chamber where the developer is conveyed by the developer supply screw 42, and a second conveyance path 62, serving as a second chamber where the developer is conveyed by the developer agitation screw 43 are provided in the partition wall 48. Then, a circulation path of the developer is formed between the first and second conveyance paths 61 and 62.

The developer agitated by the developer collection screw 44 falls by its own weight toward the developer supply screw 42 via a communication port, not shown, formed in a partition wall 63 of the developing container 60. The partition wall 63 is located between the developer collection screw 44 and the developer supply screw 42. That is, the developer that has been agitated by the developer collection screw 44 is introduced into the developer supply screw 42. To be noted, the guide member 45 described above is formed integrally with the partition wall 63, and the developer collection screw 44 is arranged above the partition wall 63.

A position of the communication port through which the developer agitated by the developer collection screw 44 falls by its own weight and is introduced into the developer circulation portion 46 is preferably arranged to avoid an area (intermediate part in the rotational axis direction of the developer supply screw 42) in which the developer is being supplied toward the first developing roller 30. In the present embodiment, the position of the communication port is set to be within a range in which a downstream end portion (ending end portion) of the first conveyance path 61 is included in the developer conveyance direction of the first conveyance path 61 in which the developer supply screw 42 is arranged.

As illustrated by arrows in FIG. 4, a developer conveyance direction in which the developer supply screw 42 conveys the developer and a developer conveyance direction in which the developer agitation screw 43 conveys the developer are directions opposite to each other. Then, a starting end side (upstream end side in the developer conveyance direction) of the first conveyance path 61, in which the developer supply screw 42 is arranged, and an ending end side (downstream end side in the developer conveyance direction) of the second conveyance path 62, in which the developer agitation screw 43 is arranged, communicate via the communication port 48b disposed in the partition wall 48. An ending end side (downstream end side in the developer conveyance direction) of the first conveyance path 61 and a starting end side (upstream end side in the developer conveyance direction) of the second conveyance path 62 communicate via the communication port 48a disposed in the partition wall 48. Therefore, the developer circulates in the rotational directions of the developer supply screw 42 and the developer agitation screw 43, as illustrated by the arrows in FIG. 3, and substantially in the horizontal direction within the developing container 60, and part of the developer is supplied toward the first developing roller 30.

A developer supply port 51 is arranged above the developer agitation screw 43 in the developing container 60, and is connected to the developer storage unit 27Y (refer to FIG. 1). Then, the developer supply port 51 is configured to supply the developer stored in the bottle, which is loaded into the developer storage unit 27Y, to the second conveyance path 62, in which the developer agitation screw 43 is arranged.

Since, as described above, the toner concentration (toner weight ratio) of the developer stored in the bottle of the developer storage unit 27Y is larger than the toner concentration of the developer in the developing unit 1Y, by adjusting the developer that is replenished to the second conveyance path 62, the toner weight ratio of the developer in the developing unit 1Y can be maintained constant.

As illustrated in FIG. 4, a developer discharge portion 53 is arranged at a most downstream position of the developer supply screw 42 in the developer conveyance direction, and discharges excess developer within the developing unit 1Y from a developer discharge port 54 to the outside of the developing unit 1Y. A screw 55 whose developer conveyance direction is opposite to the developer conveyance direction of the developer supply screw 42 is formed in the developer discharge portion 53. The screw 55 is coaxially disposed with the developer supply screw 42, and rotates in conjunction with the developer supply screw 42 to generate a flow that pushes the developer back from the developer discharge portion 53 toward the developer circulation portion 46.

In addition, downstream of the screw 55 in the developer conveyance direction of the developer supply screw 42, a screw 56 that conveys the developer in the same direction as the developer conveyance direction of the developer supply screw 42 is disposed coaxially with the developer supply screw 42 and the screw 55. The screw 56 rotates in conjunction with the developer supply screw 42 and the screw 55, conveys the developer, which has passed over the screw 55, to the developer discharge port 54, and discharges the developer from the developer discharge port 54.

Thereby, in a state in which a developer amount within the developing unit 1Y is properly maintained, a developer amount discharged from the developer discharge port 54 is suppressed by pushing the developer back using the screw 55. On the other hand, when the toner is replenished from the developer supply port 51 into the developing unit 1Y and the developer amount trying to move from the developer supply screw 42 to the developer discharge portion 53 increases, the developer moves to the screw 56 by passing over the screw 55, and the excess developer is discharged from the developer discharge port 54 to the outside of the developing unit 1Y. At this time, when rotational speeds of the developer supply screw 42 and the developer agitation screw 43 are increased, since a movement of the developer toward the developer discharge portion 53 is enhanced, the developer amount discharged from the developer discharge port 54 can be increased. On the other hand, when the rotational speeds of the developer supply screw 42 and the developer agitation screw 43 are decreased, since the movement of the developer toward the developer discharge portion 53 is suppressed, the developer amount discharged from the developer discharge port 54 can be decreased.

The toner concentration sensor 49, serving as a second inductance sensor (first magnetic permeability sensor), is arranged to detect a toner concentration within the developer contained in the developer circulation portion 46. The toner concentration sensor 49 is the inductance sensor that detects the magnetic permeability of the developer. In the detection of the magnetic permeability of the developer by the toner concentration sensor 49, for example, the output value can be stabilized by averaging the magnetic permeability of the developer over a rotation cycle of the developer agitation screw 43 in a sampling time that is equal to or more than the time required for one rotation of the developer agitation screw 43. That is, for example, the output value of the toner concentration sensor 49 is determined as an average of the output value over a period that is an integer multiple of the rotation pitch of the developer agitation screw 43. Since the toner concentration corresponds to an amount of toner consumed in the developing unit 1Y, the toner concentration is used for the control of the developer replenishment from the developer storage unit 27Y. When the controller 80 (FIG. 2), for example, detects that the toner concentration has decreased below a predetermined toner concentration, the developer is replenished from the developer storage unit 27Y (a replenishment operation is performed). That is, the controller 80 performs the replenishment operation as first control to control the replenishment unit 93 to replenish the developer to the developing container 60 based on the output value of the toner concentration sensor 49, which is generated while the driving unit 94 rotatably drives the developer supply screw 42 and the developer agitation screw 43.

To be noted, since the magnetic permeability of the developer changes depending on the toner concentration, it is possible to detect the toner concentration by using the magnetic permeability that is the output value of the toner concentration sensor 49. Since the toner concentration sensor 49 detects the magnetic permeability of the developer, the output value increases as the toner concentration decreases. That is, the toner concentration sensor 49 is configured such that a toner concentration in a case where the output value is at a second value, which is larger than a first value, decreases compared to a toner concentration in a case where the output value is at the first value. The toner concentration sensor 49 is arranged in the second conveyance path 62. In particular, the toner concentration sensor 49 is disposed, as illustrated in FIG. 3, vertically below the rotational axis of the developer agitation screw 43 and, as illustrated in FIG. 4, at a downstream end portion of the second conveyance path 62 in the developer conveyance direction of the developer agitation screw 43.

The developer surface detection sensor 50, serving as a first inductance sensor (second magnetic permeability sensor), is arranged to detect the developer surface contained in the developer circulation portion 46. The developer surface detection sensor 50 is an inductance sensor that detects the magnetic permeability of the developer. The controller 80 performs developer discharge control for maintaining the developer amount within the developing unit 1Y constant based on the developer surface detected by the developer surface detection sensor 50. The developer surface detection sensor 50 is arranged in the second conveyance path 62. In particular, the developer surface detection sensor 50 is disposed, as illustrated in FIG. 3, vertically above the rotational axis of the developer agitation screw 43 and, as illustrated in FIG. 4, upstream of the toner concentration sensor 49 in the developer conveyance direction of the developer agitation screw 43.

A detection surface (second detection portion) of the developer surface detection sensor 50 is positioned vertically above a detection surface (first detection portion) of the toner concentration sensor 49. The detection surface of the developer surface detection sensor 50 and the detection surface of the toner concentration sensor 49 are desirably arranged within a range of a distance corresponding to four pitches of a blade of the developer agitation screw 43 in the rotational axis direction of the developer agitation screw 43. With this configuration, a detection area of the toner concentration of the developer and a detection area of the developer surface can be regarded as substantially the same. In the present embodiment, one pitch of the blade of the developer agitation screw 43 is set to 30 millimeters (mm), and the detection surface of the developer surface detection sensor 50 is positioned 20 mm above the detection surface of the toner concentration sensor 49 in the vertical direction. In addition, in the rotational axis direction of the developer agitation screw 43, the detection surface of the developer surface detection sensor 50 is arranged at a position 50 mm upstream in the developer conveyance direction of the developer agitation screw 43 from the detection surface of the toner concentration sensor 49.

A regulation member 52 is arranged adjacent to the first developing roller 30, and is used to regulate the developer amount supplied from the developer circulation portion 46 to the first developing roller 30. The regulation member 52 can be, for example, configured to regulate the developer amount attracted onto the first developing roller 30 based on a gap between the surface of the first sleeve 33 of the first developing roller 30 and an end portion of the regulation member 52.

In a circulation path of the developer within the developing container 60, after the developer is conveyed substantially in the horizontal direction within the developer circulation portion 46 while being agitated, the developer is supplied to the first developing roller 30 and is transferred from the first developing roller 30 to the second developing roller 31 arranged above the first developing roller 30 based on the magnetic force. Next, after the developer is transferred from the second developing roller 31 to the peeling roller 32, arranged to the side of the second developing roller 31, based on the magnetic force, the developer is peeled off the peeling roller 32 by the third magnet 38 arranged in the peeling roller 32. Then, the developer is collected by the developer collection portion 47, and is introduced into the developer circulation portion 46 again.

### Vibration Apparatus

The image forming apparatus 100 of the present embodiment includes the vibration device 200, serving as a vibration unit applying vibrations to the developing container 60. By applying the vibrations to the developing container 60, the vibration device 200 serves to eliminate an immobile layer of the developer which is generated within the developing container 60. As illustrated in FIG. 3, the vibration device 200 is arranged on a side opposite to the photosensitive drum 28Y and above the developer circulation portion 46. In the present embodiment, the vibration device 200 is arranged vertically above the second conveyance path 62 and at a position facing a side wall 60a of the developing container 60 on an opposite side of the photosensitive drum 28Y. In addition, in the present embodiment, the vibration device 200 is arranged at a central portion in a rotational axis direction (longitudinal direction) of the first developing roller 30. To be noted, a position of the vibration device 200 is preferably vertically above the developer surface detection sensor 50. In addition, in the present embodiment, the vibration device 200 is arranged vertically upper than a detection surface of the developer surface detection sensor 50.

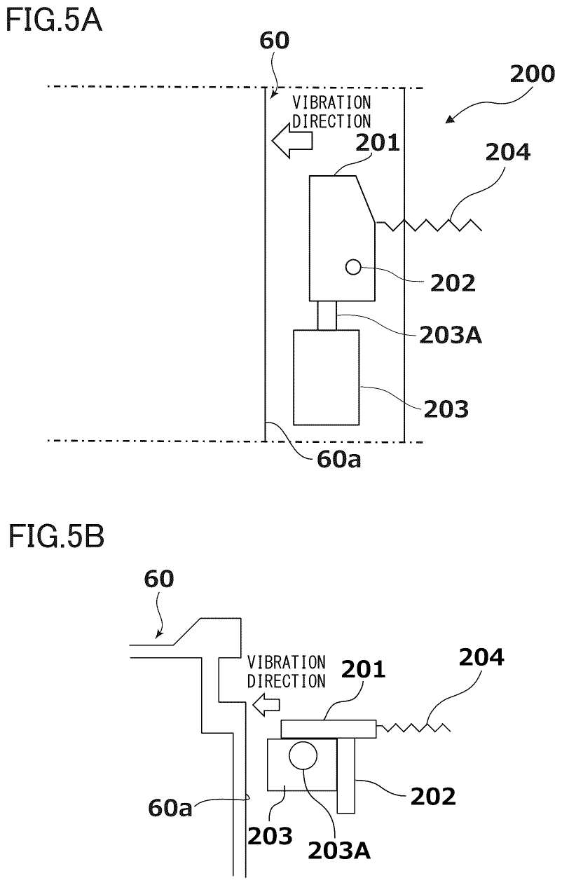

As illustrated in FIGS. 5A and 5B, the vibration device 200 includes a vibration member 201, a fixed shaft 202, an electromagnetic solenoid 203, and a return spring 204. The vibration member 201 is a component that applies the vibrations to the developing container 60, and is arranged at a position facing the side wall 60a of the developing container 60. The vibration member 201 is attached with respect to the fixed shaft 202 in a rotatable manner about the fixed shaft 202. By pivoting about the fixed shaft 202, the vibration member 201 abuts against the side wall 60a, serving as a vibrated portion, of the developing container 60, and applies the vibrations to the developing unit 1Y. A vibration direction of the vibration member 201 is set to the horizontal direction of the developing unit 1Y.

The electromagnetic solenoid 203 is a driving unit that pivots the vibration member 201. The electromagnetic solenoid 203 incorporates a plunger 203A, and operates the plunger 203A based on a control signal from the controller 80. The plunger 203A is coupled to the vibration member 201, and the vibration member 201 pivots toward the developing container 60 when the plunger 203A performs a suction operation. The return spring 204 is connected to the vibration member 201, and possesses a tensile force to return the vibration member 201 to its initial position.

Using FIGS. 5A and 5B, a vibration operation will be described. Whether or not to perform the vibration operation is determined based on the output value of the developer surface detection sensor 50 (details will be described below). Then, in a case where it is determined to perform the vibration operation, an ON signal is transmitted to the electromagnetic solenoid 203 by the control signal from the controller 80, and the plunger 203A performs the suction operation. Since the vibration member 201 is pulled by the plunger 203A when the plunger 203A is suctioned, the vibration member 201 pivots about the fixed shaft 202, and abuts against the side wall 60a of the developing container 60 by moving in arrow directions in FIGS. 5A and 5B, so that the vibrations are applied to the developing unit 1Y by the impact. After a predetermined time has passed since the output of the ON signal, the controller 80 transmits an OFF signal as a control signal to the electromagnetic solenoid 203. Thereby, the plunger 203A returns to an initial position.

During the vibration operation, the rotational control of the first and second developing rollers 30 and 31, the peeling roller 32, the developer supply screw 42, the developer agitation screw 43, and the developer collection screw 44 is stopped. With respect to the photosensitive drum 28Y, it is not necessary to stop the rotational control. In addition, the application of the vibrations to the developing unit 1Y by the vibration device 200 is sometimes employed for the following usage. In a process of supplying the toner from the developing unit 1Y to the photosensitive drum 28Y, sometimes, the toner scatters, and accumulates in the developing container 60. Furthermore, when the toner accumulated in the developing container 60 falls onto the photosensitive drum 28Y at unforeseen timing, sometimes, image defects are caused. In such cases, by performing the vibration operation onto the developing unit 1Y using the vibration device 200, the occurrence of the image defects is suppressed by dislodging the toner accumulated in the developing container 60.

In addition, the vibration operation is performed during a time of a non-image formation (i.e., during a non-developing operation in which the developing operation to develop the electrostatic latent image formed on the photosensitive drum 28Y is not performed). The time of the non-image formation includes, for example, a period before a start of the image forming job, an interval between the image forming job and the subsequent image forming job, a period during an operation for image stabilization, periods during various operational corrections, and the like. However, even during continuous image formation, it is acceptable to insert operation control to perform the vibration operation by interrupting the image forming operation midway. For example, during the continuous image formation, it is acceptable to insert operational control that interrupts the image forming operation every time images are formed on a predetermined number of the recording materials since the last execution of the vibration operation, and performs the vibration operation. To be noted, the image forming job refers to a period from the start of the image formation based on a print signal (image formation signal) for forming the image on the recording material to the completion of the image formation. That is, the image forming job refers to a period during which a series of operations: a pre-operation (pre-rotation) performed prior to the image forming operation triggered by the input of the image formation signal, the image forming operation, and a post-operation (post-rotation) performed after the image forming operation are performed.

### Developer

As described above, in the present embodiment, the two-component development method is used as a development method, and the developer that is used is a mixture of negatively charged non-magnetic toner and a carrier with magnetic properties. The non-magnetic toner includes a resin, such as polyester and styrene-acrylic, that encapsulates a colorant and a wax component, and, after being processed into a powder form through pulverization or polymerization, fine powders of titanium dioxide, silica, and the like are added to the surface. The magnetic carrier is resin coated on a surface of a core made from resin particles kneaded with ferrite particles or magnetic powder. In the present embodiment, the toner concentration in the developer (weight ratio of the toner contained in the developer) in an initial state is 9%.

Since, generally, the two-component development method, using the toner and carrier, charges both components to a predetermined polarity by bringing the toner and carrier into frictional contact, the two-component development method has a feature of imposing less stress on the toner compared to a single-component development method that uses a single-component developer. On the other hand, extended usage results in an increase in contaminants on a carrier surface (spent), and, therefore, reduces the ability to charge the toner over time. As a result, issues such as ghosting and toner scattering occur. To extend the service life of the two-component developing unit, increasing the carrier amount accommodated in the developing unit can be considered, but this will lead to an increase in the size of the developing unit, which is undesirable.

To eliminate the aforementioned issues related to the two-component developer, the present embodiment employs the auto carrier refresh (ACR) method. The ACR method involves gradually supplying fresh developer from the developer storage unit 27Y into the developing unit 1Y, while simultaneously discharging the developer with deteriorated charging performance through the developer discharge port 54 of the developing unit 1Y, and, thereby, suppresses an increase in the degraded carrier. With this configuration, the degraded carrier within the developing unit 1Y is gradually replaced with a fresh carrier, and the charging performance of the carrier in the developing unit 1Y can be maintained substantially constant.

Incidentally, in the developing unit 1Y, employing the ACR method like the present embodiment, when the usage of the developing unit 1Y is continued, due to changes in the fluidity of the developer, sometimes, a discharge amount of the developer from the developer discharge port 54 fluctuates. For example, in an early stage of the usage of the developing unit 1Y, the fluidity of the developer is high, and there is a tendency to increase the discharge amount of the developer. However, as the usage of the developing unit 1Y continues and the developer deteriorates, sometimes, the fluidity of the developer decreases, and the discharge amount of the developer is suppressed.

In a case where the developer amount within the developing unit 1Y decreases, the image defects occur because of a shortage of the developer amount necessary for the image formation. In addition, in a case where the developer amount within the developing unit 1Y becomes excessive, the overflow of the developer near the first and second developing rollers 30 and 31 or the locking of various screws arranged in the developing unit 1Y may occur. To address such circumstances, in the present embodiment, the developer surface detection sensor 50 that detects the height of the developer surface within the developing unit 1Y is disposed, and, in a case where the developer surface within the developing unit 1Y deviates from a predetermined range, developer discharge control is executed to change the number of revolutions (the rotational speeds) of the developer supply screw 42 and the develop agitation screw 43 so as to adjust to maintain the developer surface constant.

For example, in a case where the developer surface within the developing unit 1Y falls below a predetermined position, a developer discharge suppression mode to suppress the developer discharge by decreasing the rotational speeds of the developer supply screw 42 and the developer agitation screw 43 is executed. In addition, in a case where the developer surface within the developing unit 1Y surpasses the predetermined position, the image forming operation is stopped, and a developer discharge mode to discharge the excess developer to the outside of developing unit 1Y by repeatedly alternating forward and reverse rotation operations of the developer supply screw 42 and the developer agitation screw 43 for a pre-set time is executed.

That is, the rotational conditions of the developer supply screw 42 and the developer agitation screw 43 in the developer discharge mode are different from the rotational conditions of the developer supply screw 42 and the developer agitation screw 43 during the developing operation. In particular, when the developing unit 1Y performs the developing operation to develop the electrostatic latent image formed on the photosensitive drum 28Y, the driving unit 94 rotatably drives the developer supply screw 42 and the developer agitation screw 43 under a first rotational condition. On the other hand, as described below, in a case where the developer discharge mode is executed during the non-developing operation of not performing the developing operation, the driving unit 94 rotatably drives the developer supply screw 42 and the developer agitation screw 43 under a second rotational condition that is different from the first rotational condition. To be noted, the first rotational condition is, for example, to rotate the developer supply screw 42 and the developer agitation screw 43 in a first rotational direction (forward rotation). The second rotational condition is to repeatedly alternate the rotation of the developer supply screw 42 and the developer agitation screw 43 in the first rotational direction and the rotation of the developer supply screw 42 and the developer agitation screw 43 to rotate in a second rotational direction (reverse rotation) that is opposite to the first rotational direction. These developer discharge suppression mode and developer discharge mode are referred to as the developer discharge control.

To be noted, while, in the developer discharge suppression mode that is executed in the case where the developer surface within the developing unit 1Y falls below the predetermined range, the rotational speeds of the developer supply screw 42 and the developer agitation screw 43 are decreased during the time of the image formation (during the developing operation), it is not limited to this. In the case where the developer surface within the developing unit 1Y falls below the predetermined range, instead of executing the developer discharge suppression mode during the time of the image formation (during the developing operation), a variant example of executing the developer discharge suppression mode during the time of the non-image formation (during the non-developing operation) is acceptable. In this variant example, the rotational conditions of the developer supply screw 42 and the developer agitation screw 43 in the developer discharge suppression mode are different from the rotational conditions of the developer supply screw 42 and the developer agitation screw 43 during the developing operation. Further, in the case where the developer surface within the developing unit 1Y falls below the predetermined range, a variant example of executing the developer discharge suppression mode during the time of the non-image formation (during a non-developing operation), in addition to the execution during the time of the image formation (the developing operation), is acceptable.

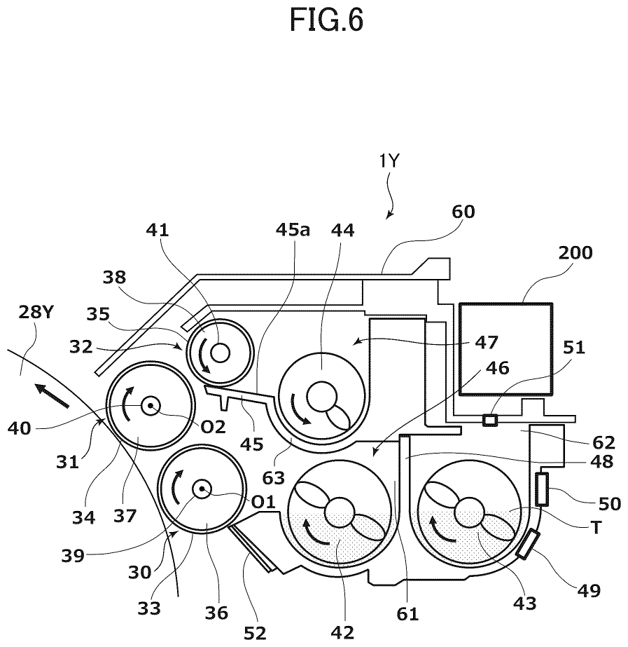

However, in the case of performing the detection of the developer surface within the developing unit 1Y using the developer surface detection sensor 50, there is a risk that the false detection of the developer surface may occur due to an immobile layer of the developer generated within the developing unit 1Y. Using FIGS. 6 to 11, such false detection of the developer surface due to the immobile layer of the developer will be described.

### False Detection of Developer Surface Due to Immobile Layer

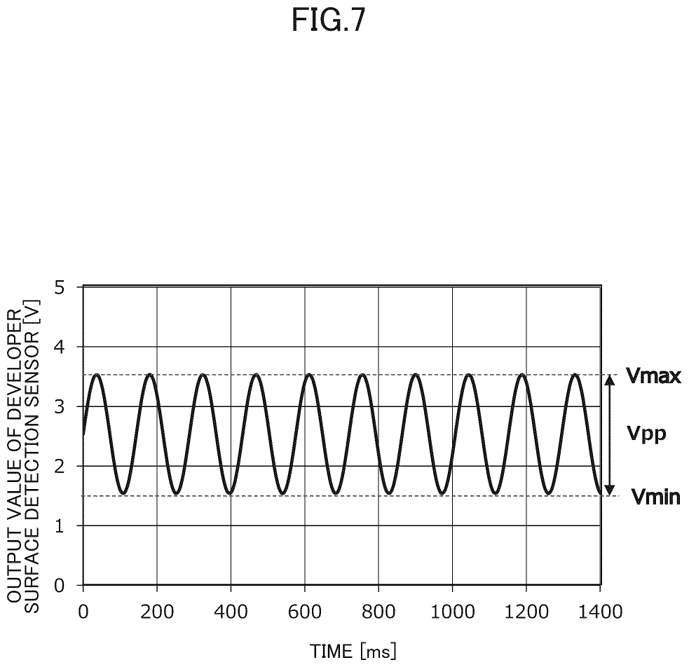

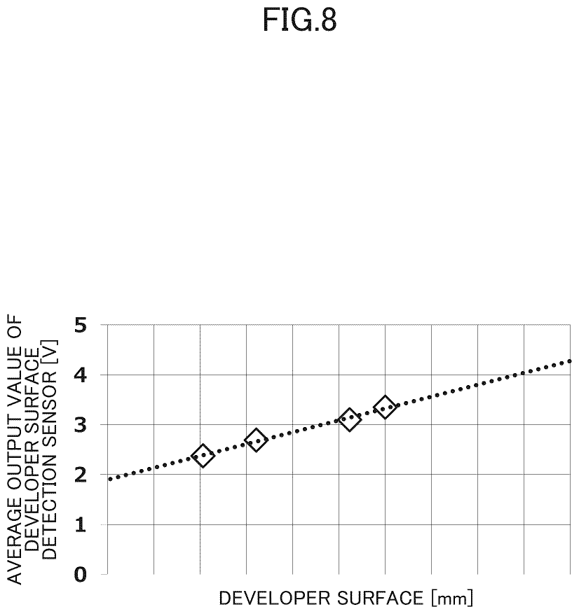

FIG. 6 is a schematic diagram illustrating a developer surface T in a case where the fluidity of the developer within the developing unit 1Y is high, and FIG. 7 is an output result of the developer surface detection sensor 50 in the state of FIG. 6. When the developer moves in a conveyance direction by the rotation of the developer supply screw 42 and the developer agitation screw 43, the developer surface T fluctuates in accordance with rotational pitches of the developer supply screw 42 and the developer agitation screw 43. Therefore, as illustrated in FIG. 7, the output value of the developer surface detection sensor 50 exhibits cyclic fluctuations. The cyclicality of the output value of the developer surface detection sensor 50 depends on the rotational speed of the developer agitation screw 43 and the number of blades thereof. At this time, the average output value of the developer surface detection sensor 50 over the predetermined time and the developer surface T within the developing unit 1Y can be correlated to a first-order linear relation as illustrated in FIG. 8.

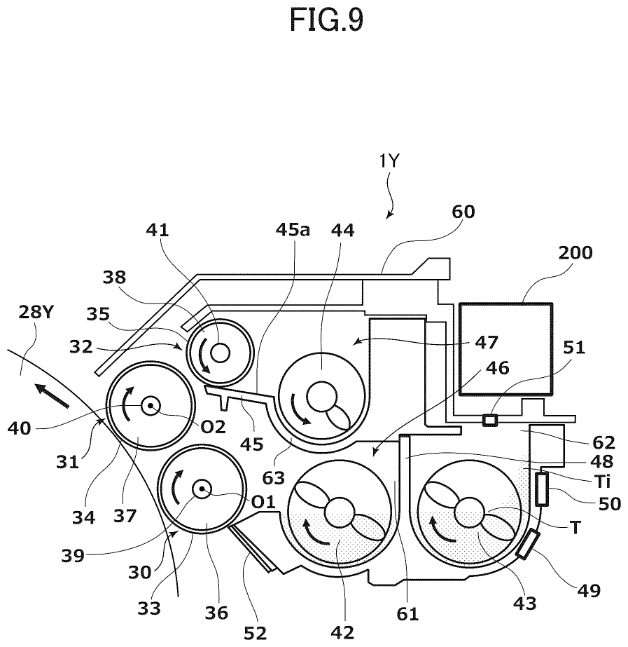

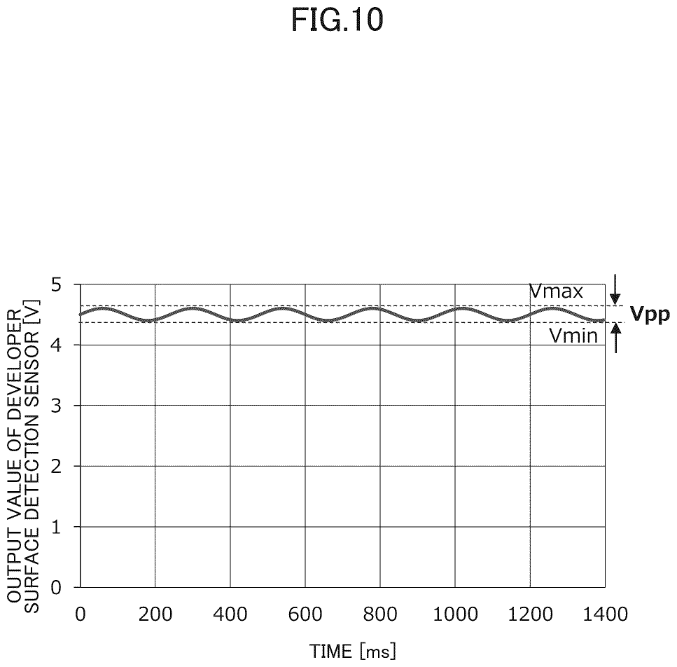

Next, FIG. 9 is a schematic diagram illustrating the developer surface T in a case where the fluidity of the developer is low, and FIG. 10 illustrates the output result of the developer surface detection sensor 50 in the state of FIG. 9. In the case where the fluidity of the developer is low, it is known that the developer tends to accumulate in a gap between the developer supply screw 43 and an inner wall of the developing container 60. In particular, since, as illustrated in FIG. 4, the developer surface detection sensor 50 is arranged in the vicinity of the most downstream side of the developer agitation screw 43 in the developer conveyance direction and in the vicinity of the communication port 48b from the second conveyance path 62 to the first conveyance path 61, a movement direction of the developer near the detection surface of the developer surface detection sensor 50 is not in one direction. Therefore, in such a case, particularly, the developer tends to accumulate near the detection surface of the developer surface detection sensor 50. As illustrated in FIG. 9, the accumulated developer continues to grow on the inner wall of the developing container 60 along the vertical direction, and, eventually, forms an immobile layer Ti.

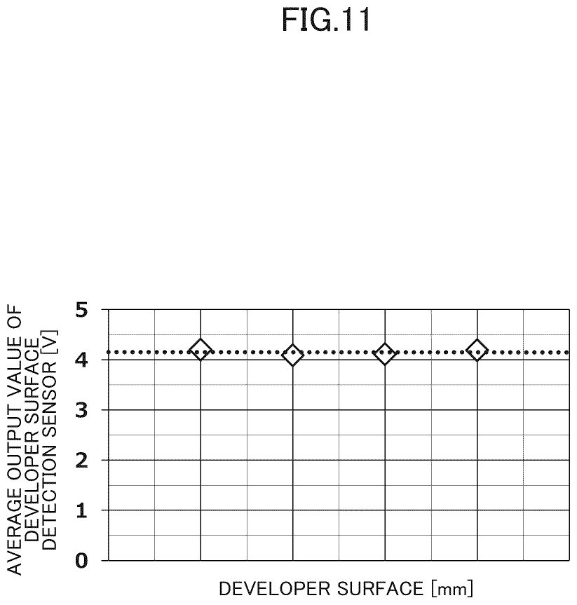

Since the developer surface detection sensor 50 detects the amount of the magnetic carrier present contained in the developer near the detection surface, in a case where the immobile layer Ti of the developer is generated near the detection surface, the developer surface detection sensor 50 is strongly affected by the immobile layer Ti. As a result, as illustrated in FIG. 10, the output value of the developer surface detection sensor 50 increases, and the amplitude of the cyclical fluctuations is reduced. At this time, a relationship is established between the average output value of the developer surface detection sensor 50 over the predetermined time and the developer surface T within the developing unit 1Y, as illustrated in FIG. 11. In FIG. 11, since the average output value of the developer surface detection sensor 50 is constant regardless of the detection surface T, it becomes difficult to correctly detect the developer surface. As described above, since the accurate detection of the developer surface is inhibited by the immobile layer Ti of the developer within the developing unit 1Y, there is a risk that the developer discharge control may not be properly executed.

### Vibration Operation

Therefore, in the present embodiment, in a case where, from the detection result of the developer surface detection sensor 50, it is determined that the immobile layer is generated within the developing unit 1Y, the immobile layer of the developer is eliminated by performing the vibration operation (second control) of applying the vibrations to the developing unit 1Y using the vibration device 200. Thereby, the false detection of the developer surface detection sensor 50 is suppressed, and it becomes possible to more accurately detect the developer surface within the developing unit 1Y.

In the present embodiment, the controller 80 controls the vibration device 200 to perform the vibration operation of applying the vibrations to the developing unit 1Y based on the output value of the developer surface detection sensor 50 that is generated while the driving unit 94 rotatably drives the developer supply screw 42 and the developer agitation screw 43. In particular, in a case where an absolute value Vpp of a difference between a maximum output value Vmax and a minimum output value Vmin of the developer surface detection sensor 50 over the predetermined time is smaller than a predetermined value Vth, the controller 80 controls the vibration device 200 to perform the vibration operation of applying the vibrations to the developing container 60. That is, in the case where Vpp is smaller than Vth, it is determined that the immobile layer of the developer is generated, and the immobile layer is eliminated by which the vibration device 200 performs the vibration operation onto the developing container 60.

Here, the predetermined time is set to a time that is an integer multiple of a rotation pitch of the developer agitation screw 43. For example, the predetermined time is set to a period equal to one pitch of the rotation of the developer agitation screw 43. In particular, in a case where the pitch of the developer agitation screw 43 is 30 millimeters (mm) and the rotational speed is 600 revolutions per minute (rpm), a required time for one pitch becomes 100 milliseconds (msec), and this is set as the predetermined time.

To be noted, considering the variation in Vpp, the predetermined time may be set as the time required for the developer to circulate one cycle through the developer circulation portion 46. In particular, in a case where the length of a circulation path within the developer circulation portion 46 is 660 mm, pitches of the developer supply screw 42 and the developer agitation screw 43 are each 30 mm, and each of the rotational speeds of the developer supply screw 42 and the developer agitation screw 43 is 600 rpm, the required time for the developer to circulate the one cycle through the circulation path becomes approximately 2.2 seconds (sec), and this is set as the predetermined time. Then, in a case where Vpp remains low even though the developer circulates one cycle through the circulation path, as described below, it is determined that the immobile layer is being generated.

In a case where the maximum value and the minimum value of the output value of the developer surface detection sensor 50 within the predetermined time are respectively referred to as Vmax and Vmin, which are illustrated in FIGS. 7 and 10, Vpp is an absolute value of a difference between Vmax and Vmin. Such Vpp is the amplitude of the cyclic variation in the output value of the developer surface detection sensor 50, and indicates the fluctuation range in the developer surface that changes with the rotation of the developer agitation screw 43. In a case where the fluidity of the developer within the developing unit 1Y is high and the immobile layer is not generated, Vpp becomes a high value. On the other hand, in a case where the fluidity of the developer within the developing unit 1Y decreases and the immobile layer of the developer is generated in the gap between the developer agitation screw 43 and the inner wall of the developing container 60, Vpp becomes a low value. This is because the developer surface detection sensor 50 detects the developer contained in the immobile layer and becomes unable to correctly detect the fluctuations of the developer surface that changes with the rotation of the developer agitation screw 43.

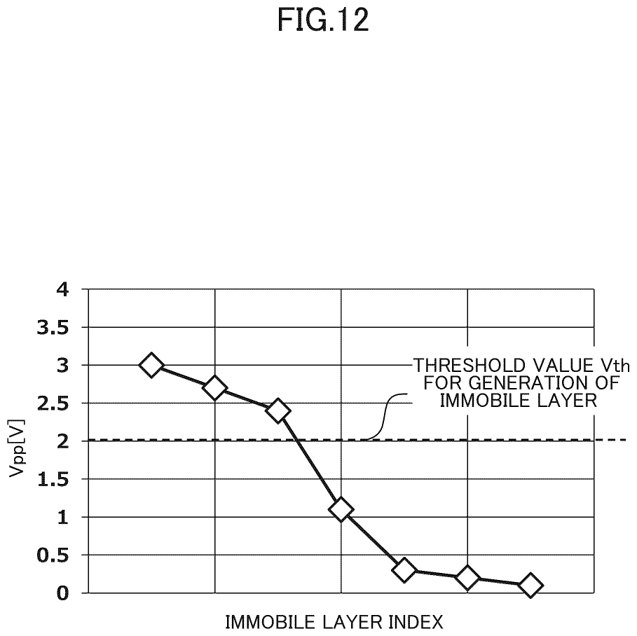

Therefore, as the immobile layer of the developer within the developing unit 1Y grows, Vpp decreases as illustrated in FIG. 12. An immobile layer index on the horizontal axis of FIG. 12 indicates the status of the immobile layer generation. As this index increases, that is, as it moves to the right on the horizontal axis of FIG. 12, it indicates that the immobile layer of the developer is growing. Accordingly, from the relationship in FIG. 12, Vpp can be used as the index that indicates the generation of the immobile layer of the developer within the developing unit 1Y. Therefore, in the present embodiment, in a case where Vpp falls below the threshold value (predetermined value) Vth, the vibration operation is performed. Accordingly, in the present embodiment, in the case where the absolute value of the difference between the maximum output value and the minimum output value of the developer surface detection sensor 50 that are generated while the driving unit 94 rotatably drives the developer supply screw 42 and the developer agitation screw 43 for the predetermined time, is smaller than the predetermined value, the controller 80 performs the vibration operation. On the other hand, in a case where the absolute value of the difference between the maximum output value and the minimum output value of the developer surface detection sensor 50 that are generated while the driving unit 94 rotatably drives the developer supply screw 42 and the developer agitation screw 43 for the predetermined time, is equal to or more than the predetermined value, the controller 80 does not perform the vibration operation.

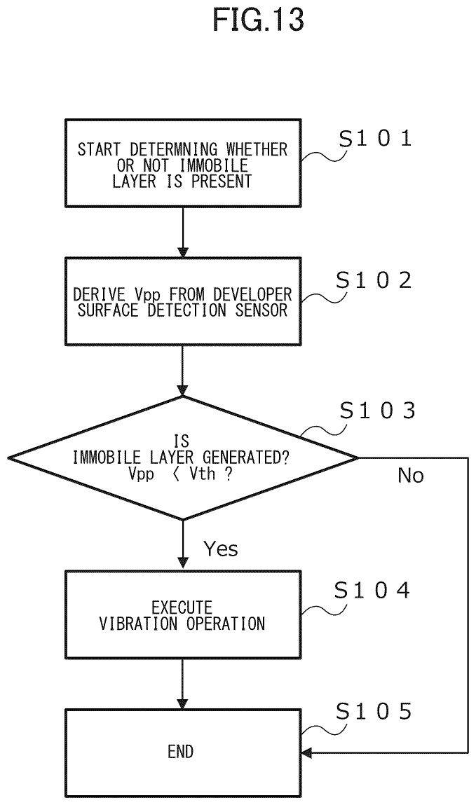

A procedure for determining whether or not the immobile layer of the developer is generated within the developing unit 1Y and executing the vibration operation will be described using a flowchart illustrated in FIG. 13. At STEP S101, a process to determine whether or not the immobile layer of the developer is generated within the developing unit 1Y is started. The timing to perform STEP S101 is during at least any of the following periods: a period of the image forming operation, a period of the pre-rotation before the image forming operation, or a period of the post-rotation after the image forming operation, and it may be performed during one or a plurality of these periods. In addition, it is preferable that the timing to start the determination process corresponds to the usage time of the developing unit 1Y, such as when the image has been formed on a predetermined number of the recording materials, and aligns with the abovementioned timeframe. To be noted, in a case where the determination process is performed during the image forming operation, when it is determined to execute the vibration operation as a result of the determination process, as described below, the image forming operation is interrupted, and the vibration operation is executed.

At STEP S102, Vpp is derived. In particular, in a state in which the developer supply screw 42 and the developer agitation screw 43 are being rotatably driven, by performing the detection using the developer surface detection sensor 50 over the predetermined time, Vpp is calculated from Vmax and Vmin during the predetermined time.

Then, at STEP S103, the controller 80 performs the process to determine whether or not the immobile layer of the developer is generated within the developing unit 1Y. The determination of the immobile layer is performed by comparing Vpp to Vth that is the threshold value for the generation of the immobile layer. In a case where Vpp falls below Vth, it is determined that the immobile layer is generated within the developing unit 1Y. In FIG. 12 described above, Vth is set to 2 volts (V), and in a case where Vpp falls below 2 V (Vpp<Vth), it is determined that the immobile layer is generated within the developing unit 1Y.

At STEP S104, in a case where, at STEP S103, it is determined that the immobile layer is generated within the developing unit 1Y (STEP S103: Yes), the vibration operation onto the developing unit 1Y by the vibration apparatus 200 is executed. For example, in a case where Vpp within the predetermined time during the image forming operation is smaller than Vth, the controller 80 interrupts the image forming operation, and executes the vibration operation. During the execution of this vibration operation, at least the rotation of the developer supply screw 42, the developer agitation screw 43, and the first and second developing rollers 30 and 31 is stopped. In the present embodiment, as described above, during the execution of the vibration operation, the rotation of first and second developing rollers 30 and 31, the peeling roller 32, the developer supply screw 42, the developer agitation screw 43, and the developer collection screw 44 is stopped. In addition, the rotation of the photosensitive drum 28Y is not stopped.

As described above, in the vibration operation, the vibration member 201 abuts against the inner wall 60a of the developing container 60, and the developing unit 1Y vibrates due to the impact. By vibrating the developing unit 1Y, the immobile layer of the developer within the developing unit 1Y is eliminated. In the present embodiment, the vibration operation performed by the vibration device 200 includes only a single impact onto the developing container 60 by the vibration member 201. Since the immobile layer of the developer within the developing container 60 accumulates in an unstable state, by applying the single impact onto the developer container 60 using the vibration member 201, the immobile layer collapses. To be noted, the vibration operation is not limited to this, and may include a plurality of impacts onto the developing container 60 by the vibration member 201.

At STEP S105, the controller 80 ends the determination of whether or not the immobile layer of the developer is generated within the developing unit 1Y. To be noted, if Vpp is equal to or more than Vth at STEP S103, the controller 80 proceeds to STEP S105.

As described above, in a case where Vpp that is the amplitude of the variation in the output value of the developer surface detection sensor 50, is smaller than Vth, that is, in a case where it is determined that the immobile layer is generated within the developing unit 1Y, the vibration operation is executed to eliminate the immobile layer. Thereby, it becomes possible to accurately detect the developer surface based on the output value of the developer surface detection sensor 50, and it is possible to properly execute the developer discharge control in accordance with the detection result of the developer surface within the developing unit 1Y.

To be noted, while, as described above, Vpp is used as the index that indicates the generation of the immobile layer of the developer, an integral value or a standard deviation of the output value of the developer surface detection sensor 50 over the predetermined time may also be used. When the immobile layer is generated, while, as illustrated in FIG. 10, the output fluctuations (variations in the output value) decreases as illustrated in FIG. 11, the average output value of the developer surface detection sensor 50 increases. Therefore, by the generation of the immobile layer, while Vpp described above decreases, the integral value of the output value over the predetermined time increases. This is because a state in which the average output value is high continues over the predetermine time. In addition, by the generation of the immobile layer, the standard deviation of the output value over the predetermined time decreases. This is because, since the output fluctuations are small, also the deviation of the output value decreases.

As described above, in a case where the integral value is used as the index, and the integral value of the output value of the developer surface detection sensor 50 over the predetermined time is larger than a predetermined integral value, the controller 80 determines that the immobile layer is generated, and executes the vibration operation. That is, in a case where the integral value of the output value of the developer surface detection sensor 50 that is generated while the driving unit 94 rotatably drives the developer supply screw 42 and the developer agitation screw 43 for the predetermined time, is larger than the predetermined integral value, the controller 80 executes the vibration operation. On the other hand, in a case where the integral value of the output value of the developer surface detection sensor 50 that is generated while the driving unit 94 rotatably drives the developer supply screw 42 and the developer agitation screw 43 for the predetermined time, is equal to or less than the predetermined integral value, the controller 80 does not execute the vibration operation.

On the other hand, in a case where the standard deviation is used as the index, and the standard deviation of the output value of the developer surface detection sensor 50 over the predetermined time is smaller than a predetermined standard deviation, the controller 80 determines that the immobile layer is generated, and executes the vibration operation. Regardless of whether the index is the integral value or the standard deviation, similar to the example described above where Vpp is used, it is possible to properly determine the generation of the immobile layer of the developer, and it is possible to eliminate the immobile layer by executing the vibration operation based on this determination. That is, in a case where the standard deviation of the output value of the developer surface detection sensor 50 that is generated while the driving unit 94 rotatably drives the developer supply screw 42 and the developer agitation screw 43 for the predetermined time, is smaller than the predetermined standard deviation, the controller 80 executes the vibration operation. On the other hand, in a case where the standard deviation of the output value of the developer surface detection sensor 50 that is generated while the driving unit 94 rotatably drives the developer supply screw 42 and the developer agitation screw 43 for the predetermined time, is equal to or more than the predetermined standard deviation, the controller 80 does not execute the vibration operation.

### Second Embodiment

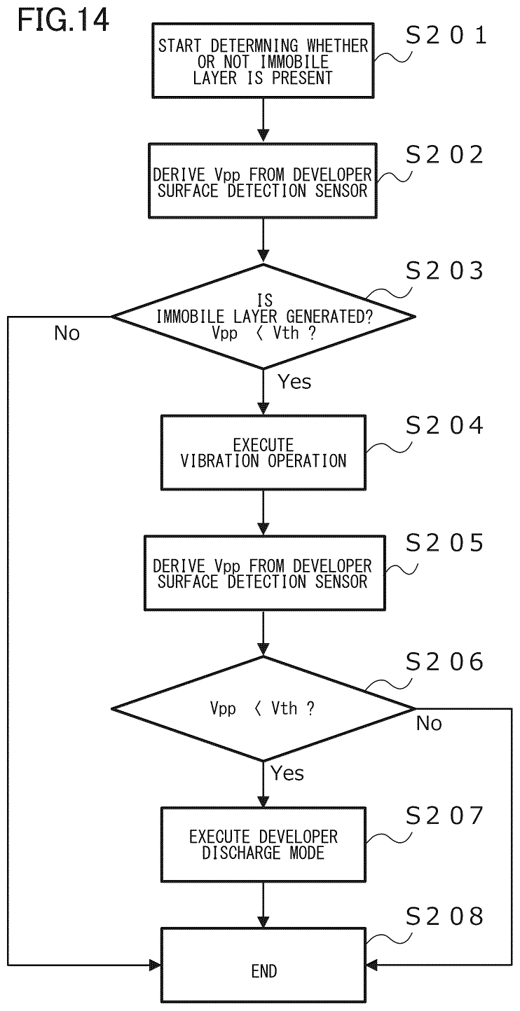

A second embodiment will be described with reference to FIG. 14. In the present embodiment, in a case where, even after the execution of the vibration operation, Vpp falls below the threshold value Vth, the controller 80 executes the developer discharge mode. Since the other configurations and functions are similar to those in the first embodiment described above, by putting the same reference characters on the similar configurations, descriptions and illustrations will be omitted or simplified, and differences from the first embodiment will be mainly described.

In the first embodiment described above, in the case where the immobile layer of the developer is generated within the developing unit 1Y, the vibration operation is performed by the vibration member 201, and, by eliminating the immobile layer, the accurate detection of the developer surface is enabled. On the other hand, in the second embodiment, in the case where Vpp that is the amplitude of the variation in the output value of the developer surface detection sensor 50, is smaller than the threshold value Vth even after the execution of the vibration operation, the controller 80 determines that the developer amount within the developing unit 1Y is excessive, and executes the developer discharge mode (third control).

In a state in which the developer amount within the developing unit 1Y becomes excessive and the developer surface surpasses the detection surface of the developer surface detection sensor 50, Vpp decreases. It is difficult to determine the state of the developer surface by identifying whether the decrease in Vpp is due to the excessive developer amount of within developing unit 1Y, as described above, or due to the generation of the immobile layer in the gap between the developer agitation screw 43 and the inner wall of the developing container 60, as described in the first embodiment. Since there is a risk that the overflow of developer or the locking of the screws may occur in a case where the developer amount within the developing unit 1Y becomes excessive, it is necessary to promptly discharge the developer from the developing unit 1Y.

Therefore, in the present embodiment, in a case where Vpp continues to be smaller than Vth after the vibration operation has been performed onto the developing unit 1Y using the vibration member 201 and the immobile layer of the developer has been eliminated, the controller 80 determines that there is a risk of the occurrence of the overflow of the developer or the locking of screws, and executes the developer discharge mode. That is, after the execution of the vibration operation, based on the output value of the developer surface detection sensor 50 that is generated while the driving unit 94 rotatably drives the developer supply screw 42 and the developer agitation screw 42, during the non-developing operation in which the developing operation is not performed, the controller 80 executes the developer discharge mode to control the driving unit 94 to rotatably drive the developer supply screw 42 and the developer agitation screw 43 under the second rotational condition. In particular, in a case where Vpp that is the absolute value of the difference between the maximum output value Vmax and the minimum output value Vmin of the developer surface detection sensor 50 over a first predetermined time, is smaller than the predetermined value Vth, the controller 80 executes the vibration operation to apply the vibrations onto the developing container 60 using the vibration device 200. In addition, after the execution of the vibration operation, in a case where Vpp over a second predetermined time is smaller than Vth, the controller 80 executes the developer discharge mode as a developer forced discharge operation to forcibly discharge the developer from the developer discharge portion 53.

To be noted, the first predetermined time is the predetermined time described in the first embodiment, the second predetermined time may either be the same as or different from the first predetermined time. However, even in a case where the second predetermined time is different from the first predetermined time, the second predetermined time is preferably set to an integer multiple of the rotation pitch of the developer agitation screw 43. In addition, as described above, the developer discharge mode is an operation in which the forward and reverse rotation of the developer supply screw 42 and the developer agitation screw 43 is repeatedly alternated for a predetermined time (third predetermined time).

The flow of such control in the present embodiment will be described with reference to a flowchart illustrated in FIG. 14. Since STEPS S201 to S204 are similar to STEPS S101 to S104 which are the control steps described in FIG. 13, details will be omitted. To be noted, the execution of this control is implemented at the same timing as the execution of STEP S101 described above. After executing the vibration operation onto the developing unit 1Y using the vibration device 200 at STEP S204, at STEP S205, similarly to STEP S202, Vpp is again derived. In particular, after the execution of the vibration operation, in the state in which the developer supply screw 42 and the developer agitation screw 43 are rotating, the controller 80 performs the detection using the developer surface detection sensor 50 for the second predetermined time, and determines Vpp from Vmax and Vmin over the predetermined time.

At STEP S206, similarly to STEP S203, the controller 80 determines whether or not Vpp is smaller than Vth. In a case where Vpp is equal to or more than Vth (STEP S206: No), it can be determined that the immobile layer has been eliminated by the vibration operation and the developer amount is not excessive. Therefore, the controller 80 moves to STEP S208, and ends the control.

On the other hand, in a case where, at STEP S206, Vpp is smaller than Vth, since the immobile layer has been eliminated by the vibration operation onto the developing unit 1Y using the vibration device 200 at STEP S204, it is determined that the developer surface within the developing unit 1Y surpasses the detection surface of the developer surface detection sensor 50 and the developer amount within the developing unit 1Y becomes excessive. That is, while the immobile layer collapses when applying the vibrations onto the developing unit 1Y, if, after the execution of the vibration operation and in the state in which the developer supply screw 42 and the developer agitation screw 43 are rotating, Vpp falls below Vth after the second predetermined time has elapsed, it can be determined that it is not due to the immobile layer but rather due to a state in which the developer surface has significantly increased.

In a case where Vpp is smaller than Vth at STEP S206 (STEP S206: Yes), the controller 80 executes the developer discharge mode. In this case, the controller 80 executes the operation to enhance the developer discharge from the developer discharge port 54 by stopping the image forming operation and repeatedly alternating the operations to rotate the developer supply screw 42 and the developer agitation screw 43 forward and reverse (second rotational condition). Then, at STEP S208, the controller 80 ends a series of the determination.

To be noted, when environmental humidity is low, the fluidity of the developer decreases compared to when the environmental humidity is high, and there is a tendency to hinder the developer discharge. Therefore, during the developer discharge mode at STEP S207, when repeatedly alternating the forward and reverse rotational operations of the developer supply screw 42 and the developer agitation screw 43 for the predetermined time, the number of revolutions (rotational speeds) of the developer supply screw 42 and the developer agitation screw 43 may be changed depending on the environmental humidity. That is, the second rotational condition may be set in accordance with the environmental humidity.

In particular, in the first rotational condition, the developer supply screw 42 and the developer agitation screw 43 rotate at a first rotational speed. In addition, in the second rotational condition, in a case where the environmental humidity is at first humidity, the developer supply screw 42 and the developer agitation screw 43 repeatedly alternate the forward and reverse rotation at a second rotational speed that is faster than the first rotational speed. On the other hand, in a case where the environmental humidity is at second humidity that is lower than the first humidity, it is acceptable to enhance the developer discharge by setting a rotational speed, at which the developer supply screw 42 and the developer agitation screw 43 repeatedly alternate the forward and reverse rotation for the predetermined time, to a third rotational speed that is faster than the second rotational speed. At this time, similarly, with respect to the developer collection screw 44, a rotational speed may be also increased.

In addition, as the rotational conditions of the developer supply screw 42 and the developer agitation screw 43 when executing the developer discharge mode at STEP S207, instead of repeatedly alternating the forward and reverse rotation of the developer supply screw 42 and the developer agitation screw 43 for the predetermined time, the following variant example may be applied.

For example, at STEP S207, it is acceptable to enhance the developer discharge by increasing the rotational speeds of the developer supply screw 42 and the developer agitation screw 43 during the execution of the developer discharge mode compared to the rotational speeds of the developer supply screw 42 and the developer agitation screw 43 during the developing operation. That is, it is acceptable to configure such that, in the first rotational condition, the developer supply screw 42 and the developer agitation screw 43 rotate at the first rotational speed, and, in the second rotational condition, the developer supply screw 42 and the developer agitation screw 43 rotate at the second rotational speed that is faster than the first rotational speed. At this time, similarly, with respect to the developer collection screw 44, the rotational speed may be also increased.

In addition, in this variant example, when executing the developer discharge mode at STEP S207, the number of revolutions (rotational speeds) of the developer supply screw 42 and the developer agitation screw 43 may be changed in accordance with the environmental humidity. This is because, as described above, when the environmental humidity is low, the fluidity of the developer is reduced compared to when the environmental humidity is high, and there is the tendency to hinder the developer discharge. Therefore, in particular, when the environmental humidity is low, the developer discharge may be enhanced by increasing the rotational speeds of the developer supply screw 42 and the developer agitation screw 43 during the execution of the developer discharge mode compared to when the environmental humidity is high. That is, it is acceptable to configure such that, when the environmental humidity is at the first humidity, the developer supply screw 42 and the developer agitation screw 43 rotate at the second rotational speed that is faster than the first rotational speed, and, when the environmental humidity is at the second humidity that is lower than the first humidity, the developer supply screw 42 and the developer agitation screw 43 rotate at the third rotational speed that is faster than the second rotational speed. At this time, similarly, with respect to the developer collection screw 44, the rotational speed may be also increased.

As described above, in the present embodiment, in the case where Vpp is low even after the execution of the vibration operation of applying the vibrations onto the developing container 1Y, the controller 80 determines that the developer amount within the developing unit 1Y is excessive, and executes the developer discharge mode. Therefore, it is possible to prevent the occurrence of the overflow of the developer and the locking of the screws in advance.

To be noted, even in the present embodiment, as the index to indicate the generation of the immobile layer of the developer, it is acceptable to use the integral value or the standard deviation of the output value of the developer surface detection sensor 50 over the predetermined time. When using the integral value as the index, in a case where integral value of the output value of the developer surface detection sensor 50 over the second predetermined time is larger than the predetermined integral value at STEPS S206 and S207, the controller 80 executes the developer discharge mode. On the other hand, when using the standard deviation as the index, in a case where the standard deviation of the developer surface detection sensor 50 over the second predetermined time is smaller than the predetermined standard deviation at STEPS S206 and S207, the controller 80 executes the developer discharge mode.

### OTHER EMBODIMENTS

While, in the embodiments described above, the developing unit includes two developing rollers, a present disclosure can be applied to a configuration in which the number of developing roller is one. That is, the present disclosure can be applied to a configuration even if the number of developing rollers for developing the electrostatic latent image on an image bearing member such as a photosensitive drum is one, and an induction sensor for detecting the developer surface within a developing container and an induction sensor for detecting the toner concentration are included.

The present disclosure is not limited to the configuration of each embodiment described above. For example, the image forming apparatus 100 is not limited to the MFP, and may be a copier, a printer, or a facsimile apparatus. In addition, as long as it is possible to convey the developer, the configurations of the developer supply screw 42, the developer agitation screw 43, and the developer collection screw 44 are not specifically limited. For example, helical blades or paddle blades can be applied.

In addition, while, in the embodiments described above, the first sleeve 33 and the photosensitive drum 28Y rotate in the same direction at the positions facing each other and the second sleeve 34 and the photosensitive drum 28Y rotate in the same direction at the positions facing each other, it is not limited to this. The present disclosure may be applied to a configuration in which the rotation center 02 of the second developing roller 31 is arranged vertically above the rotation center 01 of the first developing roller 30, the first sleeve 33 and the photosensitive drum 28Y may rotate in directions opposite to each other at the positions facing each other, and the second sleeve 34 and the photosensitive drum 28Y may rotate in directions opposite to each other at the positions facing each other. That is, the present disclosure can be applied to a counter development configuration in which the photosensitive drum 28 rotates from above toward below in the vertical direction at the positions facing the first and second development rollers 30 and 31. In addition, in a case where equal to or more than three developing rollers are included, it is also possible to apply the present disclosure to any two of the developing rollers.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-218771, filed Dec. 26, 2023, and Japanese Patent Application No. 2024-187307, filed Oct. 24, 2024 which are hereby incorporated by reference herein in their entirety.

What is claimed is:

1. An image forming apparatus comprising:
an image bearing member;
a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container;
a driving unit configured to rotatably drive the conveyance screw;
a developer replenishment unit configured to replenish the developer to the developing container;
a vibration unit configured to apply vibrations to the developing unit; and
a controller,
wherein the second detection portion is located vertically upper than the first detection portion,
wherein the controller is configured to execute first control to control the developer replenishment unit to replenish the developer to the developing container based on an output value of the first magnetic permeability sensor that is generated while the driving unit rotatably drives the conveyance screw, and
wherein the controller is configured to execute second control to control the vibration unit to perform a vibration operation to apply the vibrations to the developing unit based on an output value of the second magnetic permeability sensor that is generated while the driving unit rotatably drives the conveyance screw.

2. The image forming apparatus according to claim 1,
wherein the driving unit is configured to rotatably drive the conveyance screw under a first rotational condition during a developing operation in which the developing unit develops the electrostatic latent image formed on the image bearing member, and
wherein, after execution of the vibration operation, based on the output value of the second magnetic permeability sensor that is generated while the driving unit rotatably drives the conveyance screw, during a non-developing operation in which the developing operation is not performed, the controller is configured to execute third control to control the driving unit to rotatably drive the conveyance screw under a second rotational condition which is different from the first rotational condition.

3. The image forming apparatus according to claim 2,
wherein the first rotational condition is a condition in which the driving unit rotates the conveyance screw in a first rotational direction, and
wherein the second rotational condition is a condition in which the driving unit repeatedly alternately rotates the conveyance screw in the first rotational direction and in a second rotational direction that is opposite to the first rotational direction.

4. The image forming apparatus according to claim 2,
wherein the first rotational condition is a condition in which the driving unit rotates the conveyance screw in a first rotational direction, and
wherein, in a case where environmental humidity is at first humidity, the second rotational condition is a condition in which the driving unit repeatedly alternately rotates the conveyance screw in the first rotational direction at a first rotational speed and in a second rotational direction opposite to the first rotational direction at the first rotational speed, and, in a case where the environmental humidity is at second humidity that is lower than the first humidity, the second rotational condition is a condition in which the driving unit repeatedly alternately rotates the conveyance screw in the first rotational direction at a second rotational speed faster than the first rotational speed and in the second rotational direction at the second rotational speed.

5. The image forming apparatus according to claim 2,
wherein the first rotational condition is a condition in which the driving unit rotates the conveyance screw at a first rotational speed, and
wherein the second rotational condition is a condition in which the driving unit rotates the conveyance screw at a second rotational speed that is faster than the first rotational speed.

6. The image forming apparatus according to claim 2,
wherein the first rotational condition is a condition in which the driving unit rotates the conveyance screw at a first rotational speed, and
wherein, in a case where environmental humidity is at first humidity, the second rotational condition is a condition in which the driving unit rotates the conveyance screw at a second rotational speed that is faster than the first rotational speed, and, in a case where the environmental humidity is at second humidity that is lower than the first humidity, the second rotational condition is a condition in which the driving unit rotates the conveyance screw at a third rotational speed that is faster than the second rotational speed.

7. The image forming apparatus according to claim 1,
wherein the controller is configured to execute third control to control the vibration unit to perform the vibration operation every time images are formed on a predetermined number of recording materials.

8. The image forming apparatus according to claim 1,
wherein the vibration unit is located vertically upper than the second detection portion.

9. The image forming apparatus according to claim 1,
wherein the first detection portion and the second detection portion are arranged within a range of a distance corresponding to four pitches of a blade of the conveyance screw in a developer conveyance direction in which the conveyance screw conveys the developer.

10. An image forming apparatus comprising:
an image bearing member,
a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container;
a driving unit configured to rotatably drive the conveyance screw;
a developer replenishment unit configured to replenish the developer to the developing container;
a vibration unit configured to apply vibrations to the developing unit; and
a controller,
wherein the second detection portion is located vertically upper than the first detection portion,
wherein the controller is configured to execute first control to control the developer replenishment unit to replenish the developer to the developing container based on an output value of the first magnetic permeability sensor that is generated while the driving unit rotatably drives the conveyance screw, and
wherein, in a case where an absolute value of a difference between a maximum output value and a minimum output value of the second magnetic permeability sensor that are generated while the driving unit rotatably drives the conveyance screw for a predetermined time, is smaller than a predetermined value, the controller is configured to execute second control to control the vibration unit to perform a vibration operation to apply the vibrations to the developing unit, and
wherein, in a case where the absolute value of the difference between the maximum output value and the minimum output value of the second magnetic permeability sensor that are generated while the driving unit rotatably drives the conveyance screw for the predetermined time, is equal to or more than the predetermined value, the controller is configured not to execute the second control.

11. The image forming apparatus according to claim 10,
wherein the driving unit is configured to rotatably drive the conveyance screw under a first rotational condition during a developing operation in which the developing unit develops the electrostatic latent image formed on the image bearing member, and
wherein, after execution of the vibration operation, in a case where the absolute value of the difference between the maximum output value and the minimum output value of the second magnetic permeability sensor that are generated while the driving unit rotatably drives the conveyance screw for the predetermined time, is smaller than the predetermined value, during a non-developing operation of not performing the developing operation, the controller is configured to execute third control to control the driving unit to rotatably drive the conveyance screw under a second rotational condition which is different from the first rotational condition.

12. The image forming apparatus according to claim 11,
wherein the first rotational condition is a condition in which the driving unit rotates the conveyance screw in a first rotational direction, and
wherein the second rotational condition is a condition in which the driving unit repeatedly alternately rotates the conveyance screw in the first rotational direction and in a second rotational direction that is opposite to the first direction.

13. The image forming apparatus according to claim 11,
wherein the first rotational condition is a condition in which the driving unit rotates the conveyance screw in a first rotational direction, and
wherein, in a case where environmental humidity is at first humidity, the second rotational condition is a condition in which the driving unit repeatedly alternately rotates the conveyance screw in the first rotational direction at a first rotational speed and in a second rotational direction opposite to the first rotational direction at the first rotational speed, and, in a case where the environmental humidity is at second humidity lower than the first humidity, the second rotational condition is a condition in which the driving unit repeatedly alternately rotates the conveyance screw in the first rotational direction at a second rotational speed faster than the first rotational speed and in the second rotational direction at the second rotational speed.

14. The image forming apparatus according to claim 11,
wherein the first rotational condition is a condition in which the driving unit rotates the conveyance screw at a first rotational speed, and
wherein the second rotational condition is a condition in which the driving unit rotates the conveyance screw at a second rotational speed that is faster than the first rotational speed.

15. The image forming apparatus according to claim 11,
wherein the first rotational condition is a condition in which the driving unit rotates the conveyance screw at a first rotational speed, and
wherein, in a case where environmental humidity is at first humidity, the second rotational condition is a condition in which the driving unit rotates the conveyance screw at a second rotational speed that is faster than the first rotational speed, and, in a case where the environmental humidity is at second humidity that is lower than the first humidity, the second rotational condition is a condition in which the driving unit rotates the conveyance screw at a third rotational speed that is faster than the second rotational speed.

16. The image forming apparatus according to claim 10,
wherein the controller is configured to execute third control to control the vibration unit to perform the vibration operation every time images are formed on a predetermined number of recording materials.

17. The image forming apparatus according to claim 10,
wherein the vibration unit is located vertically upper than the second detection portion.

18. The image forming apparatus according to claim 10,
wherein the first detection portion and the second detection portion are arranged within a range of a distance corresponding to four pitches of a blade of the conveyance screw in a developer conveyance direction in which the conveyance screw conveys the developer.

19. An image forming apparatus comprising:
an image bearing member;
a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container;
a driving unit configured to rotatably drive the conveyance screw;
a developer replenishment unit configured to replenish the developer to the developing container;
a vibration unit configured to apply vibrations to the developing unit; and
a controller,
wherein the second detection portion is located vertically upper than the first detection portion,
wherein the controller is configured to execute first control to control the developer replenishment unit to replenish the developer to the developing container based on an output value of the first magnetic permeability sensor that is generated while the driving unit rotatably drives the conveyance screw, and
wherein, in a case where an integral value of an output value of the second magnetic permeability sensor that is generated while the driving unit rotatably drives the conveyance screw for a predetermined time, is larger than a predetermined integral value, the controller is configured to execute second control to control the vibration unit to perform a vibration operation to apply the vibrations to the developing unit, and
wherein, in a case where the integral value of the output value of the second magnetic permeability sensor that is generated while the driving unit rotatably drives the conveyance screw for the predetermined time, is equal to or less than the predetermined integral value, the controller is configured not to execute the second control.

20. An image forming apparatus comprising:
an image bearing member;
a developing unit including a developer bearing member configured to bear developer that contains toner and a carrier for developing an electrostatic latent image formed on the image bearing member, a developing container configured to accommodate the developer that is supplied to the developer bearing member, a conveyance screw configured to convey the developer accommodated in the developing container, a developer discharge portion configured to discharge part of the developer accommodated in the developing container, a first magnetic permeability sensor including a first detection portion configured to detect magnetic permeability of the developer accommodated in the developer container, and a second magnetic permeability sensor including a second detection portion configured to detect the magnetic permeability of the developer accommodated in the developer container;
a driving unit configured to rotatably drive the conveyance screw;
a developer replenishment unit configured to replenish the developer to the developing container;
a vibration unit configured to apply vibrations to the developing unit; and
a controller,
wherein the second detection portion is located vertically upper than the first detection portion,
wherein the controller is configured to execute first control to control the developer replenishment unit to replenish the developer to the developing container based on an output value of the first magnetic permeability sensor that is generated while the driving unit rotatably drives the conveyance screw, and
wherein, in a case where a standard deviation of an output value of the second magnetic permeability sensor that is generated while the driving unit rotatably drives the conveyance screw for a predetermined time, is smaller than a predetermined standard deviation, the controller is configured to execute second control to control the vibration unit to perform a vibration operation to apply the vibrations to the developing unit, and
wherein, in a case where the standard deviation of the output value of the second magnetic permeability sensor that is generated while the driving unit rotatably drives the conveyance screw for the predetermined time, is equal to or more than the predetermined standard deviation, the controller is configured not to execute the second control.
